(19) United States
(12) Patent Application Publication
(10) Pub. No.: US 2023/0076623 A1
(43) Pub. Date: Mar. 9, 2023

(54) CONNECTOR AND CONNECTOR UNIT

(71) Applicant: SUMITOMO WIRING SYSTEMS, LTD., Mie (JP)

(72) Inventors: Masato KAMEMURA, Mie (JP); Tomokazu KASHIWADA, Mie (JP); Ryota SAKAI, Mie (JP)

(21) Appl. No.: 17/800,372

(22) PCT Filed: Feb. 10, 2021
(86) PCT No.: PCT/JP2021/004937

§ 371 Date: Aug. 17, 2022

(30) Foreign Application Priority Data
Feb. 21, 2020 (JP) 2020-027842

(51) Int. Cl. H01R 13/11; H01R 13/516

(52) U.S. Cl. CPC H01R 13/11; H01R 13/516

(57) ABSTRACT

A problem to be solved by the present disclosure is to provide a connector and a connector unit capable of enhancing the strength of a housing. A housing (50) includes a first accommodating portion (501) configured to accommodate a part of a connecting end portion (35) and a second accommodating portion (502) configured to accommodate the part of the connecting end portion (35) and the first accommodating portion (501). The first accommodating portion (501) is open on one side in a second direction (Y), and the second accommodating portion (502) has an outer side wall (54) configured to cover the connecting end portion (35) around an axis along a first direction (Z) and open on the one side in the second direction (Y) and an outer top wall (55) configured to cover a tip side of the connecting end portion (35) in the first direction (Z).

### TECHNICAL FIELD

The present disclosure relates to a connector and a connector unit.

### BACKGROUND

Conventionally, a connector is known which includes a terminal in the form of a long plate and a housing configured to accommodate the terminal (see, for example, Patent Document 1). The housing described in Patent Document 1 includes a protection collar having a U-shaped cross-section, extending along a longitudinal direction of the terminal and configured to surround a connecting end portion of the terminal to be connected to a terminal of a mating connector, and a side wall having a U-shaped cross-section, extending along the longitudinal direction of the terminal and configured to surround the terminal and the protection collar. The protection collar and the side wall are open on a tip side in the longitudinal direction of the terminal and open on one side in a width direction orthogonal to both the longitudinal direction and a plate thickness direction of the terminal.

### Prior Art Document

### Patent Document

Patent Document 1: JP 2016-522550 A

### SUMMARY OF THE INVENTION

### Problems to Be Solved

In the connector described in Patent Document 1, the housing is open on the tip side in the longitudinal direction of the terminal and the one side in the width direction. Thus, there is a room for improvement in enhancing the strength of the housing.

The present disclosure aims to provide a connector and a connector unit capable of enhancing the strength of a housing.

### Means to Solve the Problem

The present disclosure is directed to a connector with a first terminal including a connecting end portion, and a housing configured to cover the first terminal, wherein a part of the connecting end portion projects in a first direction from one wall of the housing, the housing includes a first accommodating portion configured to accommodate the part of the connecting end portion further on the first direction side than the one wall and a second accommodating portion configured to accommodate the part of the connecting end portion and the first accommodating portion further on the first direction side than the one wall, the first accommodating portion is open on one side in a second direction intersecting the first direction, and the second accommodating portion has a side wall configured to cover the connecting end portion around an axis along the first direction and open on the one side in the second direction and a top wall configured to cover a tip side of the connecting end portion in the first direction.

The present disclosure is also directed to a connector unit with a first connector, which is the above connector, and a second connector used for electrical connection to the first connector, wherein the connecting end portion is in the form of a flat plate, a plate thickness direction of the connecting end portion intersects both the first and second directions, and the second connector includes a second terminal to be connected to the connecting end portion in the plate thickness direction.

### Effect of Invention

According to the present disclosure, it is possible to enhance the strength of a housing.

### BRIEF DESCRIPTION OF THE DRAWINGS

FIG. 1 is a perspective view of a first connector and a second connector in one embodiment.

FIG. 2 is an exploded perspective view showing the first and second connectors of the embodiment in a disassembled state.

FIG. 3 is a perspective view of the first connector of the embodiment.

FIG. 4 is a perspective view of a first terminal of the embodiment.

FIG. 5 is a section of the first connector of the embodiment.

FIG. 6 is an exploded perspective view of the second connector of the embodiment.

FIG. 7 is an exploded perspective view of the second connector of the embodiment.

FIG. 8 is a section of the first and second connectors of the embodiment.

### DETAILED DESCRIPTION TO EXECUTE THE INVENTION

### Description of Embodiments of Present Disclosure

First, embodiments of the present disclosure are listed and described.

[1] The connector of the present disclosure is provided with a first terminal including a connecting end portion, and a housing configured to cover the first terminal, wherein a part of the connecting end portion projects in a first direction from one wall of the housing, the housing includes a first accommodating portion configured to accommodate the part of the connecting end portion further on the first direction side than the one wall and a second accommodating portion configured to accommodate the part of the connecting end portion and the first accommodating portion further on the first direction side than the one wall, the first accommodating portion is open on one side in a second direction intersecting the first direction, and the second accommodating portion has a side wall configured to cover the connecting end portion around an axis along the first direction and open on the one side in the second direction and a top wall configured to cover a tip side of the connecting end portion in the first direction.

According to this configuration, since the first and second accommodating portions are open on the one side in the second direction, the connecting end portion is exposed from these openings. In this way, another terminal can be connected to the connecting end portion of the first terminal through the both openings.

Here, the connecting end portion is covered around by the side wall open on the one side in the second direction and the tip side of the connecting end portion in the first direction is covered by the top wall. Thus, the strength of the housing can be enhanced as compared to a housing not having the top wall.

[2] Preferably, when the side wall and the top wall are respectively an outer side wall and an outer top wall, the first accommodating portion has an inner side wall configured to cover the connecting end portion inside the outer side wall and an inner top wall configured to cover the connecting end portion inside the outer top wall.

According to this configuration, the first accommodating portion includes the inner side wall configured to cover the connecting end portion inside the outer side wall and the inner top wall configured to cover the connecting end portion inside the outer top wall. Thus, the strength of the housing can be enhanced as compared to a housing not having the inner top wall.

[3] Preferably, the first terminal includes a terminal body having the connecting end portion and an insulating member configured to cover a part of the connecting end portion on the one side in the second direction, the one wall is a facing wall facing the top wall, the facing wall includes an insertion hole, the first terminal being inserted into the insertion hole along the first direction, and the insulating member includes a positioning portion configured to position the first terminal in the first direction by being locked to the facing wall.

In a configuration in which a connecting end portion of a terminal is exposed through an opening of a side wall of a housing, a worker’s hand may tough the connecting end portion.

In this respect, according to the above configuration, the insulating member covers a part on the one side in the second direction, i.e. a part on the opening side of the first and second accommodating portions, out of the connecting end portion of the first terminal. Thus, it can be suppressed that a worker’s hand erroneously touches the connecting end portion.

Further, according to the above configuration, the terminal including the insulating member is inserted into the insertion hole formed in the facing wall of the housing. The terminal is positioned in the first direction by locking the positioning portion of the insulating member to the facing wall. Thus, workability in accommodating the terminal into the housing can be improved.

[4] The connector unit of the present disclosure is provided with a first connector, which is any one of the connectors of [1] to [3] described above, and a second connector used for electrical connection to the first connector, wherein the connecting end portion is in the form of a flat plate, a plate thickness direction of the connecting end portion intersects both the first and second directions, and the second connector includes a second terminal to be connected to the connecting end portion in the plate thickness direction.

According to this configuration, the connecting end portion in the form of a flat plate and the second terminal are in contact in the plate thickness direction of the connecting end portion. Thus, the terminal and the second terminal can be electrically connected by fitting the second connector along the second direction through the openings of the housing of the connector. Therefore, a connecting operation of the connector and the second connector is facilitated.

### Details of Embodiment of Present Disclosure

Specific examples of a connector and a connector connection structure of the present disclosure are described below with the drawings. In each figure, some of components may be shown in an exaggerated or simplified manner for the convenience of description. Further, a dimension ratio of each part may be different in each figure. Note that the present disclosure is not limited to these illustrations and is intended to be represented by claims and include all changes in the scope of claims and in the meaning and scope of equivalents. “Orthogonal” in this specification means not only strictly orthogonal, but also substantially orthogonal within a range in which functions and effects in an embodiment are achieved.

### Configuration of Connector Unit

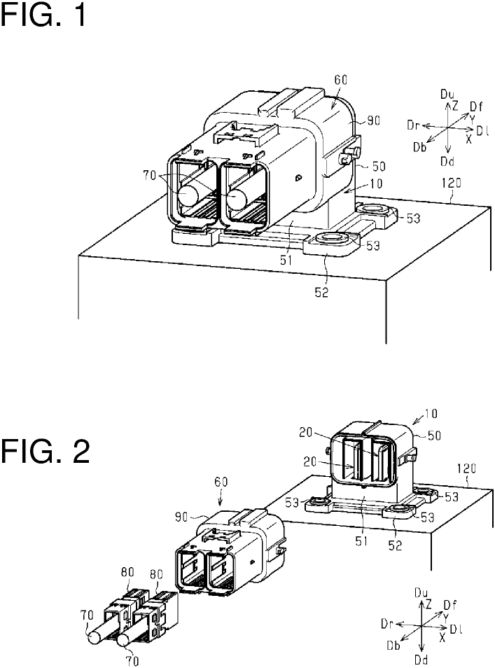

As shown in FIGS. 1 and 2, a connector unit includes a first connector 10 and a second connector 60. The first connector 10 is mounted on a case 120 of a device with a part thereof projecting from the case 120. The second connector 60 is electrically connected to the first connector 10 from a direction orthogonal to a projecting direction of the part. The first and second connectors 10, 60 are coupled to each other by an unillustrated coupling member. Note that a vertical direction in each figure does not necessarily represent postures of the first and second connectors 10, 60 in use.

### Overall Configuration of First Connector 10

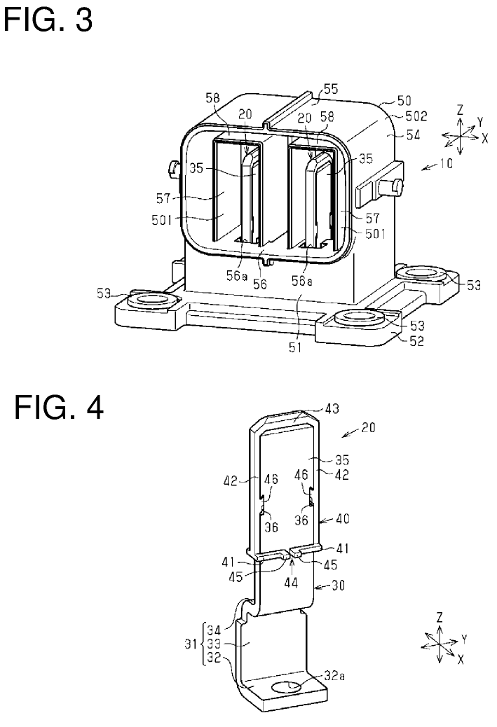

As shown in FIG. 3, the first connector 10 includes a plurality of plate-like first terminals 20 and a housing 50 made of resin for accommodating these first terminals 20. In this embodiment, two first terminals 20 are accommodated side by side in the housing 50.

### Configuration of First Terminals 20

As shown in FIG. 4, each first terminal 20 includes a terminal body 30 made of metal and having a base portion 31 and a connecting end portion 35 in the form of a flat plate extending from the base portion 31, and an insulating member 40 to be mounted on the connecting end portion 35. The terminal body 30 is formed by press-working a metal plate material of copper, copper alloy, aluminum, aluminum alloy or the like. The insulating member 40 is formed of an insulating resin material.

A first direction Z is a longitudinal direction of the connecting end portion 35 below. A second direction Y is a width direction of the connecting end portion 35 and orthogonal to the first direction Z. A third direction X is a plate thickness direction of the connecting end portion 35 and orthogonal to both the first and second directions Z, Y. In the following description, “extending along” preferably means that an angle between a reference direction and an extending direction is 10° or less. In this case, the angle between the reference direction and the extending direction is preferably 5° or less, more preferably 1° or less and most preferably 0°, i.e. these directions are parallel. Further, in the following description, “intersecting” preferably means intersecting at an angle of 80° or more with respect to a reference direction. In this case, the angle with respect to the reference direction is more preferably 85° or more, even more preferably 89° or more and most preferably 90°, i.e. perpendicular to the reference direction.

The base portion 31 includes a first straight portion 32 linearly extending along the third direction X, a second straight portion 33 bent from the first straight portion 32 and linearly extending along the first direction Z and a third straight portion 34 linearly extending along the third direction X from the second straight portion 33. The third straight portion 34 extends toward the same side as the first straight portion 32 in the third direction X. The first straight portion 32 is provided with a through hole 32a penetrating in the first direction Z.

Locking recesses 36 are provided in both side surfaces of the connecting end portion 35 in the second direction Y.

The insulating member 40 includes a surrounding portion 41 configured to surround a part of the connecting end portion 35 on the side of the base portion 31. Further, the insulating member 40 includes a pair of extending portions 42 extending from the surrounding portion 41 toward a tip side of the connecting end portion 35 along the first direction Z and configured to cover the both side surfaces of the connecting end portion 35 in the second direction Y, and a coupling portion 43 coupling the tips of the respective extending portions 42 and configured to cover the tip surface of the connecting end portion 35.

Dividing portions 44 dividing the surrounding portion 41 in a circumferential direction of the surrounding portion 41 are respectively provided in parts of the surrounding portion 41 on both sides in the third direction X. Accordingly, in each dividing portion 44, the end edges of parts of the surrounding portion 41 extending along the second direction Y are facing each other.

Positioning portions 45 projecting along the third direction X from the respective end edges are provided on both sides of the surrounding portion 41 in the third direction X.

A locking projection 46 to be locked to the locking recess 36 of the connecting end portion 35 is formed on the inner surface of each extending portion 42.

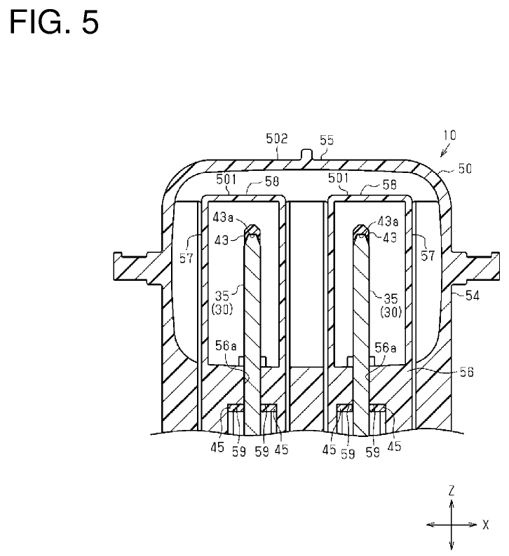

As shown in FIG. 5, the coupling portion 43 is formed with a recess 43a configured to accommodate the tip of the connecting end portion 35.

### Configuration of Housing 50

As shown in FIGS. 1 and 3, the housing 50 includes a body portion 51 configured to accommodate the both first terminals 20 and projecting along the first direction Z from the case 120, and a flange 52 projecting toward an outer peripheral side over the entire periphery of the body portion 51.

The flange 52 is provided with a plurality of hollow cylindrical collars 53. Unillustrated bolts are inserted into the respective collars and screwed into the case 120, whereby the first connector 10 is fixed to the case 120.

As shown in FIG. 3, the housing 50 includes two first accommodating portions 501 and a second accommodating portion 502. Each first accommodating portion 501 accommodates a part of the connecting end portion 35. The second accommodating portion 502 accommodates the parts of the both connecting end portions 35 and the two first accommodating portions 501.

The second accommodating portion 502 has an outer side wall 54 configured to cover the connecting end portions 35 of the both first terminals 20 around an axis along the first direction Z and open on one side in the second direction Y, an outer top wall 55 configured to cover the tip sides of the both connecting end portions 35 in the first direction Z, and a facing wall 56 facing the outer top wall 55.

The outer side wall 54 is a wall extending in a direction along the first direction X. The parts of the connecting end portions 35 of the both first terminals 20 project in the first direction Z from the facing wall 56 toward the outer top wall 55. That is, a projecting direction of the connecting end portions 35 from the facing wall 56 coincides with the first direction Z, which is a longitudinal direction of the connecting end portions 35. Further, the outer side wall 54 extends along the first direction Z, which is the projecting direction of the connecting end portions 35 from the facing wall 56.

The outer top wall 55 and the facing wall 56 are walls extending in a direction intersecting the first direction Z. The outer top wall 55 covers the both first accommodating portions 501 and the parts of the both connecting end portions 35 from the first direction Z side, more specifically, a projecting direction side of the connecting end portions 35 in the first direction Z.

The second accommodating portion 502 accommodates the parts of the both connecting end portions 35 and the both first accommodating portions 501 by forming an internal space for enclosing the parts of the both connecting end portions 35 and the both first accommodating portions 501 by the outer side wall 54, the outer top wall 55 and the facing wall 56. That is, the second accommodating portion 502 accommodates the parts of the both connecting end portions 35 and the both first accommodating portions 501 further on the first direction Z side than the facing wall 56, more specifically on the projecting direction side of the connecting end portions 35. The internal space formed by the second accommodating portion 502 has a substantially rectangular parallelepiped shape in this embodiment. Note that the projecting direction of the connecting end portions 35 is a direction from the facing wall 56 toward the tips of the connecting end portions 35 along the first direction Z.

The outer side wall 54 has a substantially U-shaped cross-sectional shape orthogonal to the first direction Z and covers both sides in the third direction X and the other side in the second direction Y of each connecting end portion 35.

The outer top wall 55 is provided to be continuous with the tip edge of the outer side wall 54 in the first direction Z. The outer top wall 55 extends along the second and third directions Y, X and perpendicularly to the first direction Z in this embodiment. That is, an extending direction of the outer top wall 55 is perpendicular to the projecting direction of the connecting end portions 35 from the facing wall 56.

The second accommodating portion 502 is open in the second direction Y. Specifically, the second accommodating portion 502 includes an opening at a position facing a wall part of the outer side wall 54 extending in a direction intersecting the second direction Y. The opening of the second accommodating portion 502 is formed by the second accommodating portion 502 not having a wall on one side in the second direction Y. An opening direction of the second accommodating portion 502 is the second direction Y, i.e. a direction perpendicular to the third direction X, which is the plate thickness direction of the connecting end portions 35. Further, the opening direction of the second accommodating portion 502 is perpendicular to the first direction Z, which is the longitudinal direction of the connecting end portions 35. Note that the second accommodating portion 502 may have a partial wall in the second direction Y, e.g. a wall serving as the outer edge of the opening of the second accommodating portion 502.

Further, the housing 50 includes, as the first accommodating portions 501, two inner side walls 57 for individually covering the respective connecting end portions 35 inside the outer side wall 54 and two inner top walls 58 for individually covering the tip sides of the respective connecting end portions 35 in the first direction Z inside the outer top wall 55.

The inner side wall 57 includes walls extending in a direction along the first direction Z. The inner top wall 58 is a wall extending in a direction intersecting the first direction Z. Further, the inner top wall 58 is facing the facing wall 56. Each of the two first accommodating portions 501 accommodates the part of the connecting end portion 35 by forming an internal space for enclosing the part of the connecting end portion 35 by the inner side wall 57, the inner top wall 58 and the facing wall 56. That is, each first accommodating portion 501 accommodates the part of the connecting end portion 35 further on the first direction Z side than the facing wall 56, more specifically on the projecting direction side of the connecting end portion 35. The internal space formed by each first accommodating portion 501 has a substantially rectangular parallelepiped shape in this embodiment.

Each inner side wall 57 has a substantially U-shaped cross-sectional shape orthogonal to the first direction Z and covers both sides in the third direction X and the other side in the second direction Y of each connecting end portion 35. In this embodiment, the inner side wall 57 extends along the first direction Z. That is, the inner side wall 57 extends along the first direction Z, which is the projecting direction of the connecting end portion 35 from the facing wall 56, similarly to the outer side wall 54.

The inner top wall 58 is provided to be continuous with the tip edge of the inner side wall 57 in the first direction Z. The inner top wall 58 extends along the second and third directions Y, X and perpendicularly to the first direction Z in this embodiment. That is, an extending direction of the inner top wall 58 is perpendicular to the projecting direction of the connecting end portion 35 from the facing wall 56.

Each first accommodating portion 501 includes an opening on the second direction Y side, specifically at a position facing a wall part of the inner side wall 57 extending in a direction intersecting the second direction Y. The opening of the first accommodating portion 501 is formed by the first accommodating portion 501 not having a wall on one side in the first direction Y in this embodiment. An opening direction of the first accommodating portion 501 is the second direction Y, i.e. a direction perpendicular to the plate thickness direction of the connecting end portion 35. Further, the opening direction of the first accommodating portion 501 is perpendicular to the longitudinal direction of the connecting end portion 35. Note that the first accommodating portion 501 may have a partial wall in the second direction Y, e.g. a wall serving as the outer edge of the opening of the first accommodating portion 501.

From the above, both the outer side wall 54 and each inner side wall 57 are open on the one side in the second direction Y. That is, the opening direction of the first accommodating portions 501 and that of the second accommodating portion 502 coincide. Through these openings, the connecting end portions 35 of the respective first terminals 20 are exposed to outside. In this embodiment, the opening of the first accommodating portion 501 is provided at a position enclosed by the opening of the second accommodating portion 502 when viewed from the second direction Y side. Note that two coinciding directions mean not only two perfectly coinciding directions, but also substantially coinciding directions. For example, that two directions coincide means that an angle formed by the two directions is less than 10°, preferably less than 5° and more preferably less than 2°.

As shown in FIG. 5, the facing wall 56 is provided with two insertion holes 56a, through which the respective first terminals 20 are inserted. An axial direction of each insertion hole 56a coincides with the first direction Z.

Further, step portions 59, to which the positioning portions 45 provided on the insulating members 40 of the respective first terminals 20 are locked in the first direction Z, are provided inside the facing wall 56. Each step portion 59 is provided to be continuous with the insertion hole 56a. By locking each positioning portion 45 to each step portion 59, a movement of each first terminal 20 toward the tip side in the first direction Z is restricted. In this way, each first terminal 20 is positioned in the first direction Z.

In this embodiment, an opening direction of each insertion hole 56a is a direction along the first direction Z, i.e. the projecting direction of the connecting end portion 35 from the facing wall 56. Further, the outer top wall 55 and the inner top walls 58 facing the respective insertion holes 56a extend in a direction intersecting the opening direction of the insertion holes 56.

### Overall Configuration of Second Connector 60

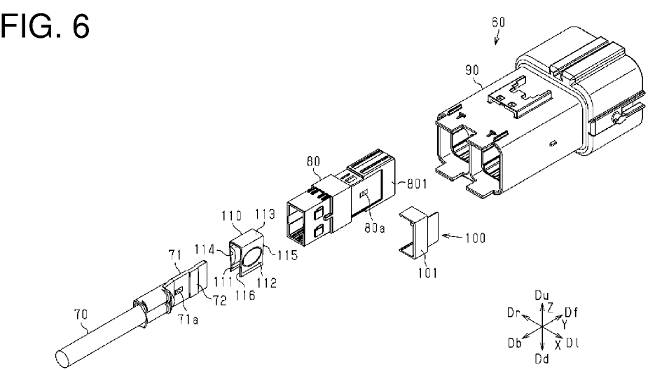

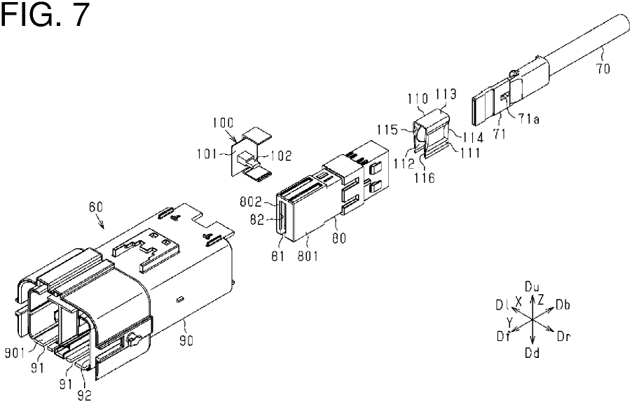

As shown in FIGS. 2, 6 and 7, the second connector 60 includes two second terminals 71 made of metal and respectively connected to the tips of two wires 70 held in parallel. Further, the second connector 60 includes two inner housings 80 in the form of rectangular tubes configured to accommodate the respective second terminals 71 and an outer housing 90 for collectively accommodating the both inner housings 80. The inner housings 80 and the outer housing 90 are both formed of a resin material. Note that one second terminal 71 and one inner housing 80 accommodating this second terminal 71 are not shown in FIGS. 6 and 7. Note that, in the following description, the first direction Z, the second direction Y and the third direction X are used as directions in a state where the second connector 60 is electrically connected to the first connector 10 when each component of the second connector 60 is described.

The second connector 60 is mounted into the first connector 10 with a direction along the second direction Y as a mounting direction. Specifically, the second connector 60 is mounted into the first connector 10 by inserting parts of the second connector 60 into the first connector 10 along the second direction Y via the openings provided in the first accommodating portions 501 and the second accommodating portion 502 of the first connector 10.

An unillustrated shield shell formed into a rectangular tube from a metal plate is interposed between each inner housing 80 and the outer housing 90.

### Configuration of Second Terminals 71

As shown in FIGS. 6 and 7, the tip of the second terminal 71 is plate-like. The second terminal 71 is accommodated in the inner housing 80 in such a posture that a plate thickness direction of the tip coincides with the third direction X. The second terminal 71 includes a bulging portion 72 bulging toward a central side of the outer housing 90 in the third direction X. The bulging portion 72 is provided over the entire second terminal 71 in the first direction Z. A part of the second terminal 71 closer to a base end side than the bulging portion 72 is formed with an engaging hole 71a penetrating in the third direction X and having a rectangular cross-sectional shape.

### Configurations of Inner Housings 80 and Outer Housing 90

As shown in FIG. 6, an engaging hole 80a having a rectangular cross-sectional shape is formed in a side surface of the inner housing 80 on the central side of the outer housing 90 in the third direction X.

As shown in FIG. 7, the inner housing 80 includes a first wall 801, a second wall 802, a first slit 81 provided in the first wall 801 and a second slit 82 provided in the second wall 802. The first and second slits 81, 82 have openings enabling the entrance of the connecting end portion 35 of the first connector 10 into the inner housing 80. The first wall 801 is a wall located on the side of the facing wall 56 of the first connector 10 at the time of mounting, out of walls intersecting the first direction Z. The second wall 802 is a wall intersecting the second direction Y and on the tip side of the inner housing 80 in the mounting direction of the second connector 60.

In describing a positional relationship of each component below, a front side Df, a rear side Db, an upper side Du, a lower side Dd, a left side Dl and a right side Dr are used in addition to the first, second and third directions Z, Y and X.

A direction toward the front side Df is the mounting direction, in which the second connector 60 advances in mounting the second connector 60 into the first connector 10. In mounting the second connector 60 into the first connector 10, the direction toward the front side Df is a direction coinciding with a direction along the second direction Y from the outside toward the inside of the first connector 10 via the openings of the first accommodating portions 501. A direction toward the rear side Db is a direction opposite to the direction toward the front side Df. That is, in mounting the second connector 60 into the first connector 10, the direction toward the rear side Db coincides with a direction along the second direction Y from the inside toward the outside of the first connector 10 via the openings of the first accommodating portions 501.

A direction toward the upper side Du is a direction intersecting the direction toward the front side Df and a direction along an opening direction of the first slit 81 from the outside toward the inside of the inner housing 80. In mounting the second connector 60 into the first connector 10, the direction toward the upper side Du coincides with a direction along the first direction Z from the facing wall 56 toward the tips of the connecting end portions 35 in the first connector 10. A direction toward the lower side Dd is a direction intersecting the direction toward the front side Df and opposite to the direction toward the upper side Du. In mounting the second connector 60 into the first connector 10, the direction toward the lower side Dd coincides with a direction along the first direction Z from the tips of the connecting end portions 35 toward the facing wall 56 in the first connector 10.

A direction toward the right side Dr is a direction toward right in the case of viewing the second connector 60 from the front side Df with the direction toward the upper side Du coinciding with a vertical direction, out of directions intersecting perpendicularly to the direction toward the upper side Du and the direction toward the front side Df. A direction toward the left side Dl is a direction opposite to the direction toward the right side Dr, out of the directions intersecting perpendicularly to the direction toward the upper side Du and the direction toward the front side Df. In mounting the second connector 60 into the first connector 10, the direction toward the right side Dr and the direction toward the left side Dl are directions extending along the third direction X.

Note that, if these directions need not be distinguished, a vertical direction Du, Dd, a lateral direction Dl, Dr and a front-rear direction Df, Db may be used. The vertical direction Du, Dd is a direction parallel to the direction toward the upper sides Du and the direction toward the lower side Dd. The lateral direction Dl, Dr are a direction parallel to the direction toward the left side Dl and the direction toward the right side Dr. The front-rear direction Df, Db is a direction parallel to the direction toward the front side Df and the direction toward the rear side Db. Note that the two wires 70 are pulled out toward the rear side Db from the inner housings 80 and the outer housing 90.

As shown in FIG. 7, the first slit 81 has an opening extending along the second direction Y from an end on the front side Df toward the rear side Db in the first wall 801, which is a wall of the inner housing 80 on the lower side Dd. An extending direction of the first slit 81 coincides with the mounting direction. The first slit 81 links the outside and inside of the inner housing 80 via the opening extending along the front-rear direction Df, Db. Thus, the opening of the first slit 81 extends along the mounting direction of the second connector 60 and the second direction Y.

As shown in FIG. 7, the second slit 82 has an opening extending along the vertical direction Du, Dd from an end on the lower side Dd toward the upper side Du in the second wall 802, which is a wall of the inner housing 80 on the front side Df. An extending direction of the second slit 82 coincides with the first direction Z, which is the projecting direction of the connecting end portion 35 in the first connector 10. The second slit 82 links the outside and inside of the inner housing 80 via the opening extending along the vertical direction Du, Dd. The second slit 82 is provided at a position coinciding with the first slit 81 in the lateral direction Dl, Dr. Further, the second slit 82 is provided up to a wall on the lower side Dd provided with the first slit 81, and coupled to the first slit 81. That is, the first and second slits 81, 82 are continuously provided. In this way, the inner housing 80 has an L-shaped opening provided over the wall on the front side Df and the wall on the lower side Dd. Therefore, a part of the connecting end portion 35 can be inserted into the inner housing 80 via the first and second slits 81, 82 when the inner housing 80 is mounted into the first connector 10. Opening widths of the first and second slits 81, 82 in the lateral direction Dl, Dr are larger than a plate thickness of the connecting end portion 35. In this embodiment, the opening width of the first slit 81 in the lateral direction Dl, Dr is substantially equal to that of the second slit 82 in the lateral direction Dl, Dr.

A pair of third slits 91 extending along the front-rear direction Df, Db are formed side by side in the lateral direction Dl, Dr in a lower part on a tip side of the outer housing 90, i.e. on the lower side Dd on the side of the first connector 10 in the front-rear direction Df, Db. Each third slit 91 is formed at a position corresponding to the first slit 81 of each inner housing 80 in the lateral direction Dl, Dr. The third slit 91 has an opening extending along the front-rear direction Df, Db from an end on the front side Df toward the rear side Db in a third wall 901 on the lower side Dd, out of walls of the outer housing 90 extending in directions intersecting the vertical direction Du, Dd. An extending direction of the third slit 91 coincides with the mounting direction, similarly to the extending direction of the first slit 81.

As shown in FIG. 7, the outer housing 90 is formed with an opening 92 having an opening direction extending toward the front side Df. The opening 92 formed in the outer housing 90 has the opening direction extending in parallel to the opening direction of the openings of the first connector 10. In this embodiment, the opening 92 of the outer housing 90 is formed by not providing a wall on the front side Df. The first accommodating portions 501 of the first connector 10 can be introduced into the outer housing 90 of the second connector 60 by the opening 92 provided in the outer housing 90. Note that the outer housing 90 may have a wall, e.g. a wall serving as the outer edge of the opening 92 of the outer housing 90, on the front side Df.

The first and third slits 81, 91 are provided to overlap when viewed from the lower side Dd. Each slit 81, 82, 91 can suppress the mutual interference of each inner housing 80 and the outer housing 90 with each terminal body 30 when the second connector 60 is connected to the first connector 10.

### Configuration of Retainer 100

As shown in FIGS. 6 and 7, the inner housing 80 is provided with a retainer 100. The retainer 100 includes a body portion 101 configured to cover the side surface of the inner housing 80 and a projection 102 projecting from the body portion 101 toward the inner housing 80. The projection 102 is inserted into both the engaging hole 80a of the inner housing 80 and the engaging hole 71a of the second terminal 71 accommodated in the inner housing 80. In this way, the inner housing 80 and the second terminal 71 are engaged with the retainer 100, wherefore the second terminal 71 is fixed to the inner housing 80.

### Configuration of Leaf Spring 110

As shown in FIGS. 6 and 7, a leaf spring 110 made of metal is accommodated inside the inner housing 80. The leaf spring 110 is, for example, made of iron, iron alloy, copper, copper alloy or the like. The leaf spring 110 is, for example, made of SUS (Steel Use Stainless). The leaf spring 110 includes a plate-like base end portion 113, a first resilient piece 111 cantilevered from one end of the base end portion 113, and a second resilient piece 112 cantilevered from the other end of the base end portion 113. The leaf spring 110 can change a distance in the lateral direction Dl, Dr between the first and second resilient pieces 111 and 112 by being resiliently deformed. The base end portion 113 extends in the front-rear direction Df, Db and lateral direction Dl, Dr. The first resilient piece 111 extends toward the lower side Dd from the one end of the base end portion 113 in the lateral direction Dl, Dr. The second resilient piece 112 extends from the other end of the base end portion 113 in the lateral direction Dl, D toward the lower side Dd. The second resilient piece 112 is facing the first resilient piece 111 in the third direction X. The leaf spring 110 has an accommodation space capable of accommodating a part of the first terminal 20 and a part of the second terminal 71. The leaf spring 110 has a U-shaped cross-sectional shape orthogonal to the front-rear direction Df, Db.

The leaf spring 110 includes a first opening 114 and a second opening 115. The first opening 114 is provided on a side opposite to the front side Df, i.e. the second slit 82. The second opening 115 is provided on the front side Df, i.e. on the side of the second slit 82. The first and second openings 114, 115 have an opening direction extending in parallel to the opening direction of the first connector 10. That is, the opening direction of the first and second openings 114, 115 coincide with the mounting direction. The first and second openings 114, 115 are openings extending toward the lower side Dd from the base end portion 113. Extending directions of the first and second openings 114, 115 coincide with the extending direction of the second slit 82. That is, the extending directions of the first and second openings 114, 115 coincide with the projecting direction of the connecting end portion 35 in the first connector 10. The outside and inside of the leaf spring 110 are linked via the first and second openings 114, 115. The second terminal 71 can be introduced into the accommodation space inside the leaf spring 110 by the second opening 115 of the leaf spring 110.

The leaf spring 110 includes a third opening 116 open on the lower side Dd. An opening direction of the third opening 116 coincides with the projecting direction of the connecting end portion 35. The leaf spring 110 includes the third opening 116 on the lower side Dd, i.e. on the side of the first slit 81. The third opening 116 is an opening extending from an end part on the front side Df toward an end part on the rear side Db of the tip of the first resilient piece 111. That is, the third opening 116 is also an opening extending from an end part on the front side Df toward an end part on the rear side Db of the tip of the second resilient piece 112. An extending direction of the third opening 116 coincides with the extending direction of the first slit 81. That is, the extending direction of the third opening 116 is parallel to the opening direction of the first connector 10. The outside and inside of the leaf spring 110 are linked via the third opening 116.

The positions of the first, second and third openings 114, 115 and 116 coincide with the positions of the first, second and third slits 81, 82 and 91 in the lateral direction Dl, Dr. That is, the first opening 114, the second opening 115 and the second slit 82 are provided side by side on a straight line along the front-rear direction Df, Db. Further, the third opening 116 and the first slit 81 are provided to overlap when viewed from the lower side Dd. The third opening 116 and each slit 81, 91 can suppress the mutual interference of the leaf spring 110, each inner housing 80, the outer housing 90 and each terminal body 30 when the second connector 60 is connected to the first connector 10.

The second opening 115 and the second slit 82 are provided to overlap when viewed from the front side Df. An end part of the second opening 115 on the upper side Du is disposed higher than an end part of the second slit 82 on the upper side Du. That is, the base end portion 113 of the leaf spring 110 is disposed higher than the end part of the second slit 82 on the upper side Du. In the lateral direction Dl, Dr, a width of the second opening 115 is larger than that of the second slit 82. That is, in the lateral direction Dl, Dr, an interval between an end part of the first resilient piece 111 on the front side Df and an end part of the second resilient piece 112 on the front side Df is larger than the width of the second slit 82. The second opening 115 and the second slit 82 can suppress the mutual interference of the leaf spring 110, the inner housing 80 and each terminal body 30 when the second connector 60 is connected to the first connector 10.

The leaf spring 110 is arranged further on the front side Df than the projection 102 of the retainer 100 inside the inner housing 80. The leaf spring 110 is arranged to sandwich a part of the second terminal 71 provided with the bulging portion 72 in the lateral direction Dl, Dr (third direction X).

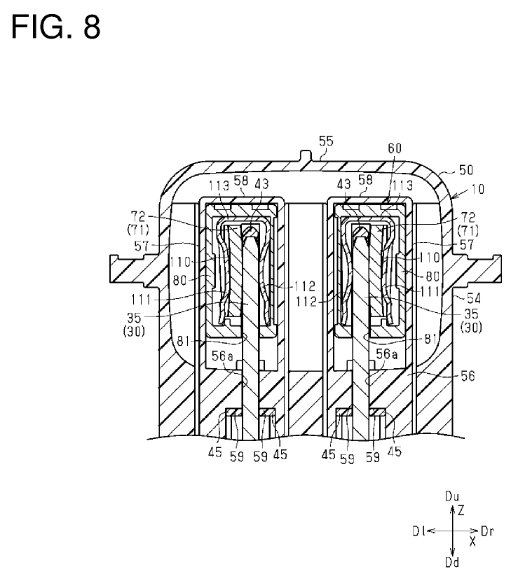

As shown in FIG. 8, with the first and second connectors 10, 60 electrically connected, the terminal body 30 and the second terminal 71 are sandwiched in the lateral direction Dl, Dr by the leaf spring 110. More particularly, in the lateral direction Dl, Dr (third direction X), the first resilient piece 111 presses the second terminal 71 toward the terminal body 30 and the second resilient piece 112 presses the terminal body 30 toward the second terminal 71. In this way, the connecting end portion 35 of the terminal body 30 and the bulging portion 72 of the second terminal 71 contact each other in the lateral direction Dl, Dr (third direction X). In this way, the first and second terminals 20, 71 are electrically connected. Note that the outer housing 90 is not shown in FIG. 8.

### Functions and Effects of this Embodiment are Described.

(1) The housing 50 includes the first accommodating portions 50 configured to accommodate the parts of the connecting end portions 35 and the second accommodating portion 502 configured to accommodate the parts of the connecting end portions 35 and the first accommodating portions 501. The first accommodating portions 501 are open on the one side in the second direction Y, and the second accommodating portion 502 includes the outer side wall 54 configured to cover the connecting end portions 35 around the axis along the first direction Z and open on the one side in the second direction Y and the outer top wall 55 configured to cover the tip sides of the connecting end portions 35 in the first direction Z.

According to this configuration, since the first and second accommodating portions 501, 502 are open on the one side in the second direction Y, the connecting end portions 35 are exposed from these openings. In this way, the second terminals 71 can be connected to the connecting end portions 35 of the first terminals 20 through the both openings.

Here, the connecting end portions 35 are covered around by the outer side wall 54 open on the one side in the second direction Y, and the tip sides of the connecting end portions 35 in the first direction Z are covered by the outer top wall 55. Thus, the strength of the housing 50 can be enhanced as compared to a housing not having the outer top wall 55.

(2) The first accommodating portion 501 includes the inner side wall 57 configured to cover the connecting end portion 35 inside the outer side wall 54 and the inner top wall 58 configured to cover the connecting end portion 35 inside the outer top wall 55.

According to this configuration, the first accommodating portion 501 has the inner side wall 57 configured to cover the connecting end portion 35 inside the outer side wall 54 and the inner top wall 58 configured to cover the connecting end portion 35 inside the outer top wall 55. Thus, the strength of the housing 50 can be enhanced as compared to a housing not having the inner top wall 58.

(3) The first terminal 20 includes the terminal body 30 having the connecting end portion 35 and the insulating member 40 configured to cover the both side surfaces of the connecting end portion 35 in the second direction Y. The insulating member 40 includes the positioning portions 45 configured to position the first terminal 20 in the first direction Z by being locked to the step portions 59 of the facing wall 56.

In a configuration in which the connecting end portions 35 of the first terminals 20 are exposed through the opening of the outer side wall 54 of the housing 50, a worker’s hand may tough the connecting end portions 35 such as during an assembling operation of the first connector 10.

In this respect, according to the above configuration, the insulating member 40 covers a part on the one side in the second direction Y, i.e. a part on the opening side of the outer side wall 54, out of the connecting end portion 35 of the first terminal 20. Thus, it can be suppressed that the worker’s hand erroneously touches the connecting end portion 35.

Further, according to the above configuration, the first terminal 20 including the insulating member 40 is inserted into the insertion hole 56a formed in the facing wall 56 of the housing 50. The first terminal 20 is positioned in the first direction Z by locking the positioning portions 45 of the insulating member 40 to the step portions 59 of the facing wall 56. Thus, workability in accommodating the first terminal 20 into the housing 50 can be improved.

(4) The connector unit includes the first and second connectors 10, 60. The connecting end portion 35 is in the form of a flat plate. The second terminal 71 is in contact with the connecting end portion 35 in the third direction X.

According to this configuration, the connecting end portion 35 in the form of a flat plate and the second terminal 71 are in contact in the plate thickness direction of the connecting end portion 35. Thus, the first terminal 20 and the second terminal 71 can be electrically connected by fitting the second connector 60 along the second direction Y through the opening of the housing 50 of the first connector 10. Therefore, a connecting operation of the first and second connectors 10, 60 is facilitated.

### Modifications

This embodiment can be modified and carried out as follows. This embodiment and the following modifications can be carried out in combination without technically contradicting each other.

The connecting end portion 35 is not limited to the one having a flat plate shape and may have, for example, a hollow cylindrical shape. Even in this case, the insulating member 40 may cover a part of the connecting end portion 35 on the one side in the second direction Y.

The positioning portions 45 of the insulating member 40 can be omitted.

The insulating member 40 may cover at least a part of the connecting end portion 35 on the one side in the second direction Y and the extending portion 42 on the other side in the second direction Y and the coupling portion 43 can also be omitted.

The insulating members 40 can also be omitted.

The inner side walls 57 and the inner top walls 58 can also be omitted.

The formation positions of the openings in the outer side wall 54 and the inner side walls 57 can be appropriately changed according to the shape of the first terminals 20 and the connecting direction of the first connector 60 to the first connector 10 as long as these formation positions are changed in a direction orthogonal to the first direction Z.

The first connector 10 may include one first terminal 20 or three or more first terminals 20. In this case, the number of the second terminal(s) 71 of the second connector 60 may be appropriately changed according to the number of the first terminal(s) 20.

In the above embodiment, the first accommodating portion 501 has walls extending planarly and form the substantially rectangular parallelepiped internal space. However, the first accommodating portion 501 is not limited to this and may have another shape. For example, the first accommodating portion 501 may have curved walls or walls having irregularities. Further, the first accommodating portion 501 may form an internal space having a shape other than a substantially rectangular parallelepiped shape, e.g. an internal space having one of various shapes such as a dome shape and a hollow cylindrical shape.

In the above embodiment, the second accommodating portion 502 has walls extending planarly and form the substantially rectangular parallelepiped internal space. However, the second accommodating portion 502 is not limited to this and may have another shape. For example, the second accommodating portion 502 may have curved walls or walls having irregularities. Further, the second accommodating portion 502 may form an internal space having a shape other than a substantially rectangular parallelepiped shape, e.g. an internal space having one of various shapes such as a dome shape and a hollow cylindrical shape.

In the above embodiment, the inner housing 80 has the first and second slits 81, 82. However, the inner housing 80 is not limited to this and may have another structure. For example, the inner housing 80 may have an opening having an opening direction similar to that of the first slit 81, instead of the first slit 81. Further, the inner housing 80 may have an opening having an opening direction similar to that of the second slit 82, instead of the second slit 82.

In the above embodiment, the outer housing 90 has the third slits 91. However, the outer housing 90 is not limited to this and may have another structure. For example, the outer housing 90 may have openings having an opening direction similar to that of the third slits 91, instead of the third slits 91.

Technical concepts that can be grasped from the above embodiment and modifications are described.

### Addendum 1

A connector provided with:
a plurality of terminals;
a plurality of inner housings provided as many as the terminals and each configured to accommodate each of the plurality of terminals; and
an outer housing configured to collectively accommodate the plurality of inner housings,
wherein:
the inner housing includes:
   a first opening open downward in one direction intersecting a mounting direction of the connector; and
   a second opening provided to be continuous with the first opening and open in the mounting direction,
the outer housing includes:
   a third opening open downward; and
   a fourth opening provided to be continuous with the third opening and open in the mounting direction,
the first and third openings are provided at positions overlapping when viewed from below, and
the second and fourth openings are provided at positions overlapping when viewed from the mounting direction.

For example, in the case of mounting a connector to a mating connector including terminals extending along one direction intersecting a mounting direction, the terminals of the mating connector interfere with a housing if the connector includes the housing open only in the mounting direction or if the connector includes the housing open only in the one direction intersecting the mounting direction.

According to this connector, when the terminals of the mating connector extend along the one direction intersecting the mounting direction, it can be suppressed that the terminals of the mating connector as a connection object interfere with the inner housings and the outer housing when the mating connector is mounted into the inner housings and the outer housing.

Note that the connector described in (Addendum 1) corresponds to the second connector 60. Further, the terminals described in (Addendum 1) correspond to the second terminals 71.

### Addendum 2

The connector of Addendum 1, wherein the inner housing includes:
a first wall located on the lower side;
a second wall located on a tip side in the mounting direction;
a first slit provided as the first opening in the first wall; and
a second slit provided as the second opening in the second wall,
the first slit extends along the mounting direction from a tip of the first wall in the mounting direction, and
the second slit extends along the one direction from the first slit.

According to this connector, the strength of the inner housing is improved as compared to the case where the first and second walls are not provided. Further, a risk of entrance of an external matter into the inner housing can be reduced as compared to the case where the first and second walls are not provided. Further, the first and second slits function as a guide for introducing the mating terminal to the inside of the inner housing.

### Addendum 3

The connector of Addendum 2, wherein the outer housing includes:
a third wall intersecting the one direction;
a third slit provided as the third opening in the third wall; and
the third slit is provided as many as the first opening in the third wall and extends along the mounting direction from a tip of the third wall in the mounting direction.

According to this connector, the strength of the outer housing is improved as compared to the case where the third wall is not provided. Further, a risk of entrance of an external matter into the outer housing can be reduced as compared to the case where the third wall is not provided. Further, the third slit functions as a guide for introducing the mating terminal to the inside of the outer housing.

### Addendum 4

The connector of any one of Addendum 1 to Addendum 3, wherein:
the connector includes a U-shaped leaf spring arranged to sandwich the terminal in a lateral direction intersecting the mounting direction and the one direction inside the inner housing, and
the leaf spring is arranged to be open in the mounting direction and downward.

According to this connector, when the terminal of the mating connector extends along the one direction intersecting the mounting direction, it can be suppressed that the terminal of the mating connector as a connection object interferes with the leaf spring in mounting the mating connector into the inner housings and the outer housing.

### LIST OF REFERENCE NUMERALS

Db rear side
Dd lower side
Df front side
Dl left side
Dr right side
Du upper side
X third direction
Y second direction
Z first direction
10 first connector
20 first terminal
30 terminal body
31 base portion
32 first straight portion
32a through hole
33 second straight portion
34 third straight portion
35 connecting end portion
36 locking recess
40 insulating member
41 surrounding portion
42 extending portion
43 coupling portion
43a recess
44 dividing portion
45 positioning portion
46 locking projection
50 housing
51 body portion
52 flange
53 collar
54 outer side wall
55 outer top wall
56 facing wall
56a insertion hole
57 inner side wall
58 inner top wall
59 step portion
60 second connector
70 wire
71 second terminal
71a engaging hole
72 bulging portion
80 inner housing
80a engaging hole
81 first slit (first opening)
82 second slit (second opening)
90 outer housing
91 third slit (third opening)
92 opening (fourth opening)
100 retainer
101 body portion
102 projection
110 leaf spring
111 first resilient piece
112 second resilient piece
113 base end portion
114 first opening
115 second opening
116 third opening
120 case
501 first accommodating portion
502 second accommodating portion
801 first wall
802 second wall
901 third wall

1. A connector, comprising:
a first terminal including a connecting end portion; and
a housing configured to cover the first terminal,
wherein:
a part of the connecting end portion projects in a first direction from one wall of the housing,
the housing includes:
a first accommodating portion configured to accommodate the part of the connecting end portion further on the first direction side than the one wall; and
a second accommodating portion configured to accommodate the part of the connecting end portion and the first accommodating portion further on the first direction side than the one wall,
the first accommodating portion is open on one side in a second direction intersecting the first direction, and
the second accommodating portion has a side wall configured to cover the connecting end portion around an axis along the first direction and open on the one side in the second direction and a top wall configured to cover a tip side of the connecting end portion in the first direction.

2. The connector according to claim 1, wherein, when the side wall and the top wall are respectively an outer side wall and an outer top wall, the first accommodating portion has an inner side wall configured to cover the connecting end portion inside the outer side wall and an inner top wall configured to cover the connecting end portion inside the outer top wall.

3. The connector according to claim 1 , wherein:
the first terminal includes a terminal body having the connecting end portion and an insulating member configured to cover a part of the connecting end portion on the one side in the second direction,
the one wall is a facing wall facing the top wall,
the facing wall includes an insertion hole, the first terminal being inserted into the insertion hole along the first direction, and
the insulating member includes a positioning portion configured to position the first terminal in the first direction by being locked to the facing wall.

4. A connector unit, comprising:
a first connector, the first connector being the connector according to claim 1 ; and
a second connector used for electrical connection to the first connector,
wherein:
the connecting end portion is in the form of a flat plate,
a plate thickness direction of the connecting end portion intersects both the first and second directions, and
the second connector includes a second terminal to be connected to the connecting end portion in the plate thickness direction.
